(19) United States
(12) Patent Application Publication
(10) Pub. No.: US 2026/0079509 A1
(43) Pub. Date: Mar. 19, 2026

(54) Thermostatic Pressure Balance Valve

(71) Applicant: AS America, Inc., Piscataway, NJ (US)

(72) Inventors: Hsiao Chang LI, Edison, NJ (US); Walter PITSCH, Washington, NJ (US)

(73) Assignee: AS America, Inc., Piscataway, NJ (US)

(21) Appl. No.: 18/994,136

(22) PCT Filed: Aug. 8, 2023
(86) PCT No.: PCT/US2023/029729

§ 371 Date: Jan. 14, 2025

Related U.S. Application Data
(60) Provisional application No. 63/396,722, filed on Aug. 10, 2022.

(51) Int. Cl. G05D 23/13

(52) U.S. Cl. CPC G05D 23/136

(57) ABSTRACT

A thermostatic pressure balance valve assembly, comprising a manifold; a thermostatic valve; and pressure balancing device, wherein the manifold comprises a hot water inlet configured to receive hot water from a hot water source, a cold water inlet configured to receive cold water from a cold water source, a central chamber, and a pressure balancing cavity, the thermostatic valve is positioned in the manifold central chamber, and the pressure balancing device is positioned in the pressure balancing cavity.

### BACKGROUND

A thermostatic shower valve may be set to a desired water temperature, for example about 105° F., by rotating an associated handle to a certain position. Thermostatic valves have a handle for water temperature control. A thermostatic valve may be associated with a separate diverter valve to control on/off. Once set, a water temperature handle need not be manipulated each time. A thermostatic valve provides direct control over a water output temperature. A hot water heater may be set to a high temperature to prevent bacterial growth, and, for safety, a thermostatic valve may be set to have a lower maximum output temperature, for instance no more than for example about 110° F. A thermostatic valve may comprise a wax element configured to react to temperature changes and to balance a hot/cold water ratio continuously.

A pressure balance valve (PBV) is able to maintain a shower water temperature if hot or cold water pressure fluctuates due to simultaneous operation of another water fixture coupled to the water lines. For instance, flushing a toilet may cause cold water pressure to drop, which may otherwise result in scalding water during a shower. A pressure balance valve is configured to adjust a hot/cold water pressure ratio to maintain a desired water temperature. Sudden changes in water pressure may reduce water flow from a shower head, but the temperature will remain about the same. A pressure balance valve comprises a device, for instance a sliding disc on a piston or on a spool, configured to maintain a pressure balance of hot and cold water. Pressure balance valves have one handle that controls water temperature and on/off. With the handle turned all the way, water delivered from a pressure balance valve may be as hot as water in a water heater.

Desired is a shower valve having the advantages of both a thermostatic valve and a pressure balance valve.

### SUMMARY

Accordingly, disclosed is a thermostatic pressure balance valve assembly, comprising a manifold; a thermostatic valve; and pressure balancing device, wherein the manifold comprises a hot water inlet configured to receive hot water from a hot water source, a cold water inlet configured to receive cold water from a cold water source, a central chamber, and a pressure balancing cavity, the thermostatic valve is positioned in the manifold central chamber, and the pressure balancing device is positioned in the pressure balancing cavity.

Also disclosed is a manifold for a thermostatic pressure balance valve assembly, wherein the manifold comprises a hot water inlet configured to receive hot water from a hot water source, a cold water inlet configured to receive cold water from a cold water source, a central chamber, and a pressure balancing cavity, the central chamber is configured to receive a thermostatic valve, and the pressure balancing cavity is configured to have a pressure balancing device positioned therein.

Also disclosed is a thermostatic pressure balance rough-in valve assembly comprising a rough-in valve and the thermostatic pressure balance valve assembly described herein, wherein the rough-in valve comprises a central chamber, a hot water inlet, a cold water inlet, and an outlet, the thermostatic pressure balance valve assembly is positioned in the rough-in valve central chamber, the rough-in valve hot water inlet is aligned with and in fluid communication with the manifold hot water inlet, the rough-in valve cold water inlet is aligned with and in fluid communication with the manifold cold water inlet, and the rough-in valve outlet is in fluid communication with the manifold outlet.

Also disclosed is a shower valve assembly comprising a diverter valve assembly and the thermostatic pressure balance rough-in valve assembly as described herein, wherein the diverter valve assembly comprises a diverter valve positioned in a diverter rough-in valve, the diverter valve assembly comprises an inlet and two or more outlets, and the thermostatic pressure balance rough-in valve assembly outlet is coupled to the diverter valve assembly inlet.

Present thermostatic pressure balance valve assemblies may provide for significant water, energy, and time savings during a shower “warm-up” period. Present thermostatic pressure balance valve assemblies may also provide for significant energy and water savings for a full shower. Present thermostatic pressure balance valve assemblies may also provide for improved anti-scald performance and enhanced temperature control. With some shower valves, water temperature fluctuations may increase at lower flow rates. The thermostatic pressure balance valve assemblies of the disclosure may provide for improved anti-scald performance at lower flow rates. In some embodiments, a present thermostatic pressure balance valve assembly may provide about 20% water savings per shower, about 10% energy savings per shower, about a ⅔ reduction in warm-up time, and may provide for up to about 3 times better scald protection, compared to a conventional pressure balance valve (PBV).

### BRIEF DESCRIPTION OF THE DRAWINGS

This disclosure is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A, FIG. 1B, and FIG. 1C provide a views of a valve manifold, according to some embodiments.

FIG. 1D and FIG. 1E show cross-section views of a valve manifold, according to some embodiments.

FIG. 1F and FIG. 1G provide views of a thermostatic pressure balance valve positioned in a valve manifold, according to some embodiments.

FIG. 1H and FIG. 1I show cross-section views of a thermostatic pressure balance valve/manifold assembly, according to an embodiment.

FIG. 1J, FIG. 1K, and FIG. 1L provide views of a rough-in assembly comprising a thermostatic pressure balance valve/manifold assembly positioned in a rough-in valve, according to some embodiments.

FIG. 1M shows a cross-section view of a thermostatic pressure balance rough-in valve assembly containing a thermostatic pressure balance valve/manifold assembly positioned in a rough-in valve, according to an embodiment.

FIG. 1N provides a view of a shower valve assembly, according to an embodiment.

FIG. 2A and FIG. 2B show views of a valve manifold, according to some embodiments.

FIG. 2C and FIG. 2D provide cross-section views of a valve manifold, according to some embodiments.

FIG. 2E and FIG. 2F show views of a thermostatic pressure balance valve positioned in a valve manifold, according to some embodiments.

FIG. 2G and FIG. 2H show cross-section views of a rough-in assembly comprising a thermostatic pressure balance valve/manifold assembly positioned in a rough-in valve, according to some embodiments.

FIG. 2I provides a view of a rough-in assembly comprising a thermostatic pressure balance valve/manifold assembly positioned in a rough-in valve, according to an embodiment.

### DETAILED DESCRIPTION

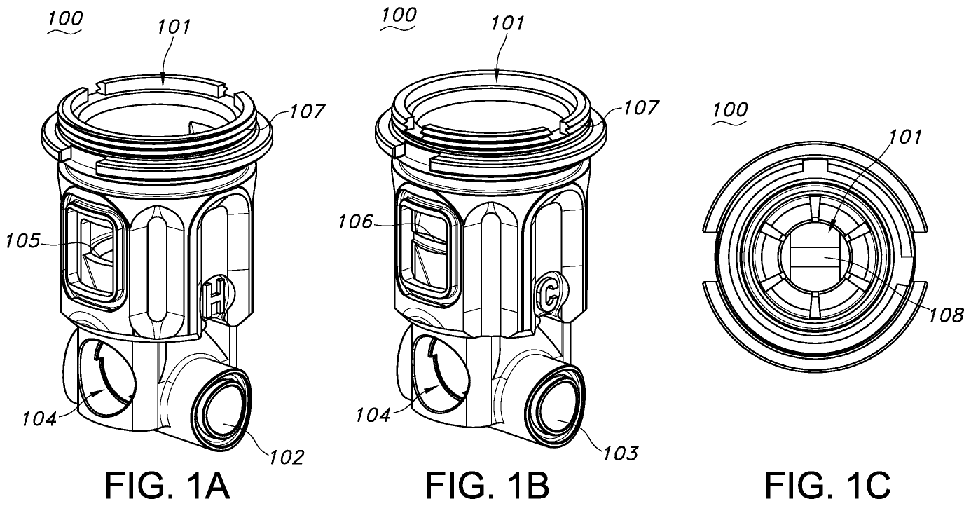

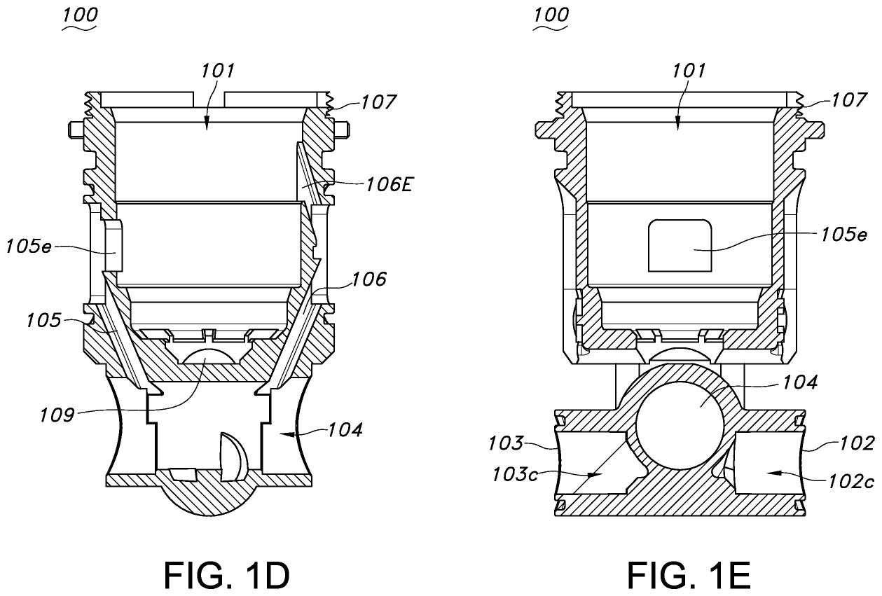

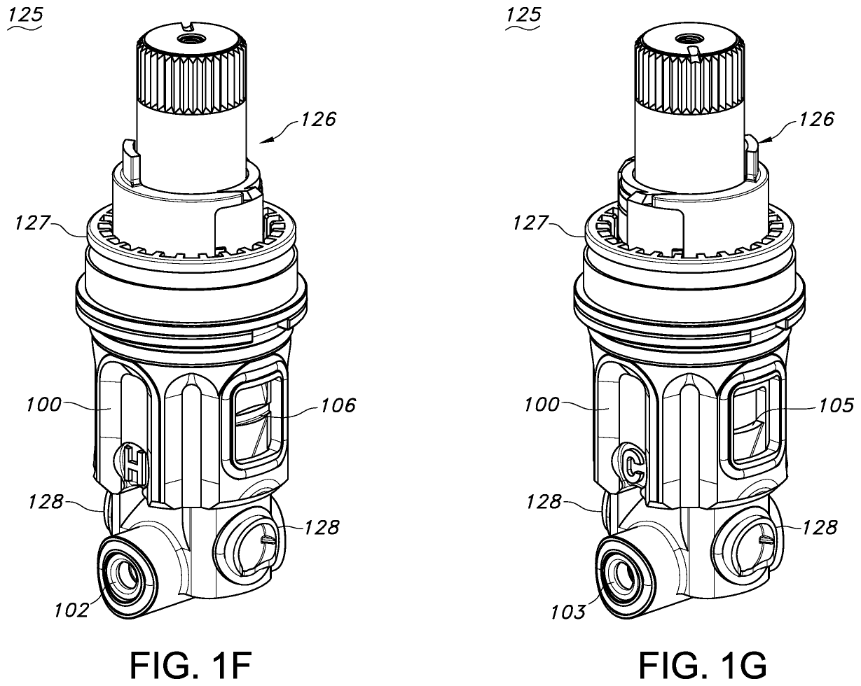

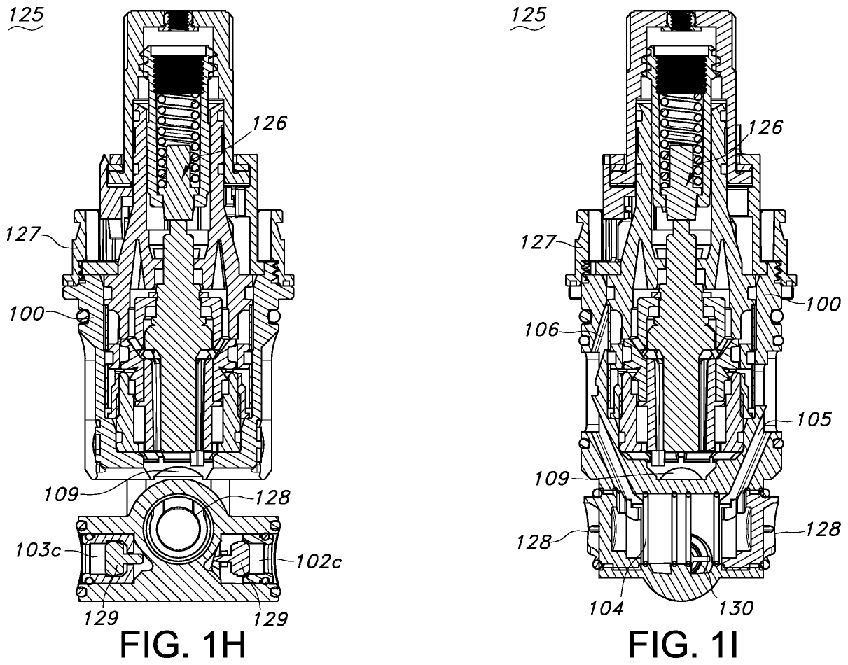

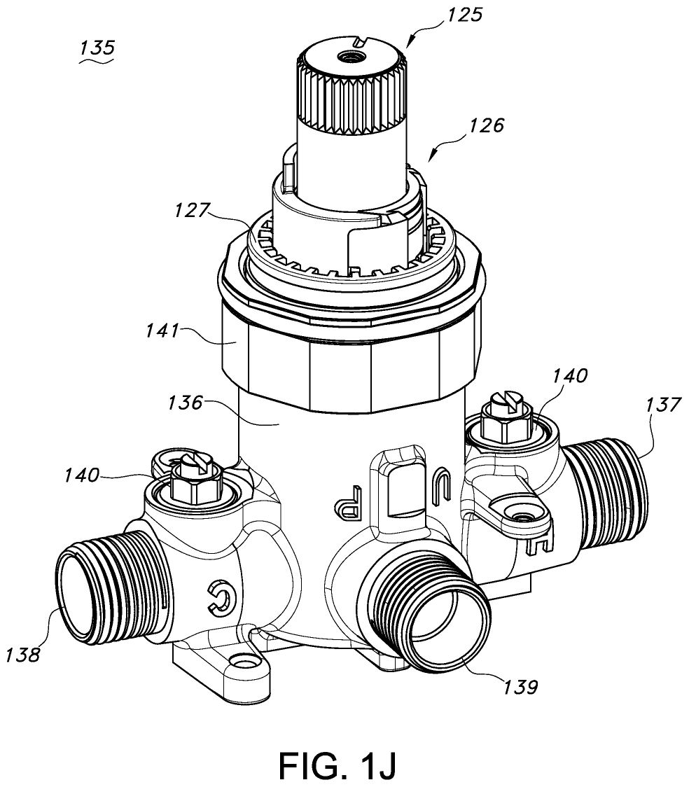

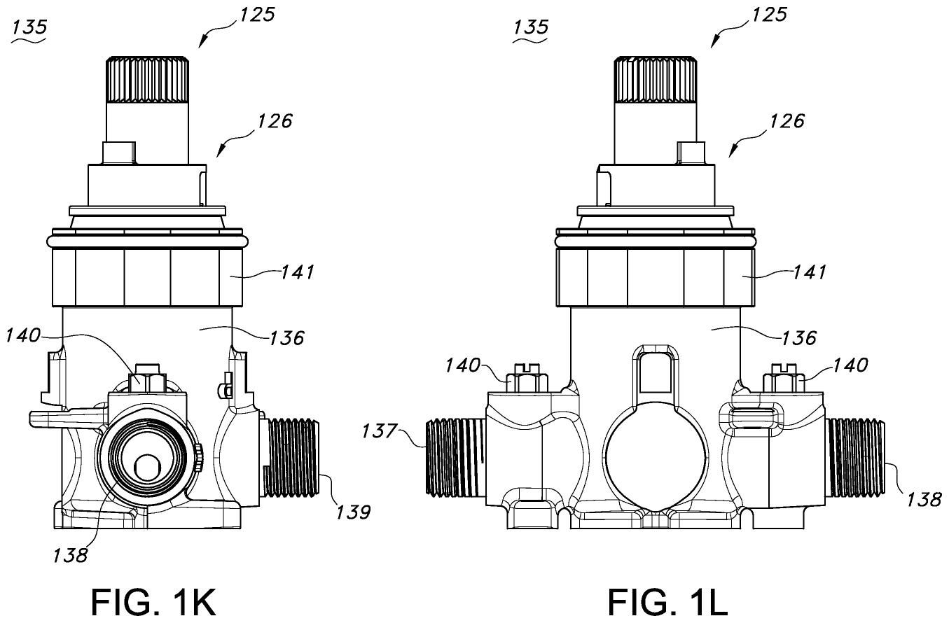

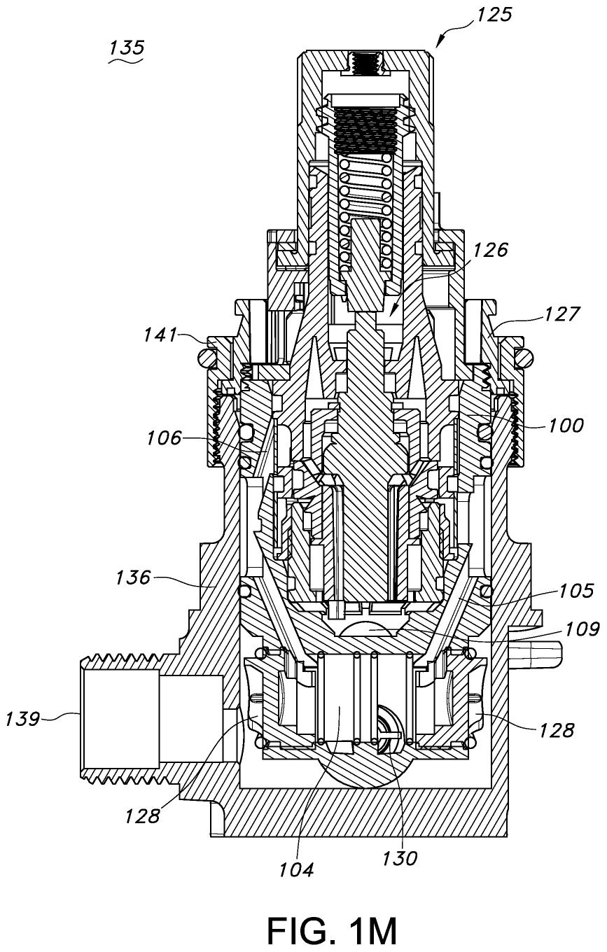

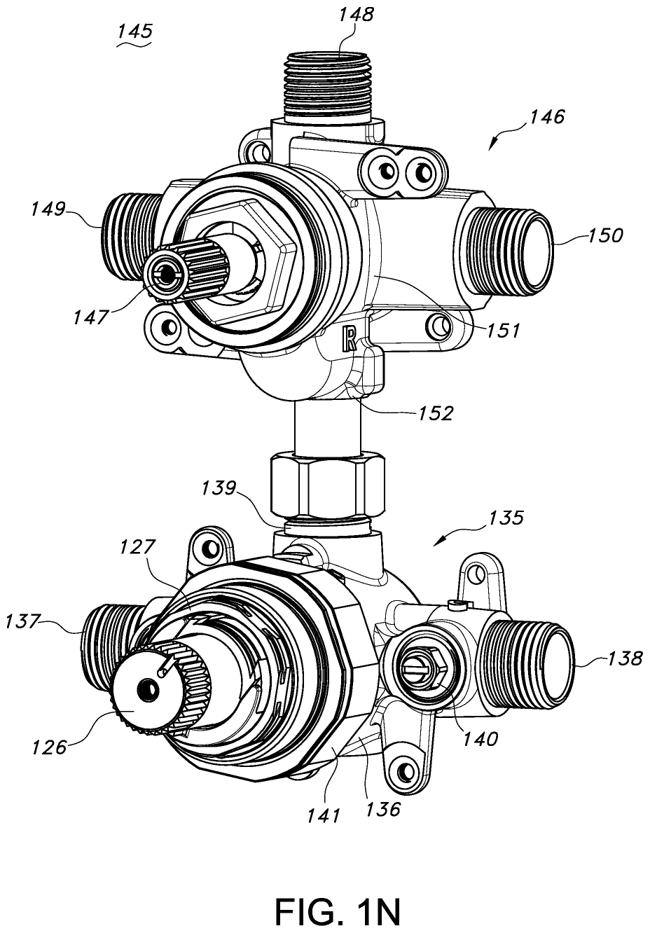

FIG. 1A and FIG. 1B show opposite side views of valve manifold 100, according to some embodiments. FIG. 1C provides a top view of manifold 100. Manifold 100 comprises central chamber 101, having a central axis and configured to receive a thermostatic valve. Manifold chamber 101 extends from a proximate end of manifold 100 towards a distal end of the manifold. Manifold 100 contains inlet 102, configured to receive hot water from a hot water source, and inlet 103, configured to receive cold water from a cold water source. Inlets 102 and 103 are configured to pass hot and cold source water to pressure balancing cavity 104, configured to receive a pressure balancing device. Balancing cavity 104 comprises a central axis perpendicular to the axis of chamber 101. Inlets 102 and 103 are positioned near a distal end of manifold 100, and balancing cavity 104 is positioned adjacent inlets 102 and 103 and closer to the proximate end of manifold 100 than are inlets 102 and 103. Inlets 102 and 103 comprise a central axis perpendicular to a central axis of balancing cavity 104. Manifold 100 comprises passage 105, configured to direct hot water from balancing cavity 104 to a mid-section of a thermostatic valve, and passage 106, configured to direct cold water from balancing cavity 104 to an upper section of a thermostatic valve. Manifold 100 comprises upper threaded surface 107, positioned at a proximate end of manifold 100, and configured to couple to a threaded surface of a bonnet nut to secure a thermostatic valve in chamber 101. Manifold 100 comprises central passage 108 configured to deliver mixed water from a thermostatic valve to manifold outlet 109 (FIG. 1D and FIG. 1E).

FIG. 1D and FIG. 1E provide cross-section views of valve manifold 100, according to some embodiments. FIG. 1D provides a horizontal cross-section view of FIG. 1C, and FIG. 1E provides a vertical cross-section view of FIG. 1C. Passage 105 comprises exit point 1056, configured to deliver hot water from balancing cavity 104 to a thermostatic valve positioned in chamber 101, and passage 106 comprises exit point 1066, configured to deliver cold water from balancing cavity 104 to a thermostatic valve. Manifold 100 comprises outlet 109 configured to deliver hot/cold mixed water from a thermostatic valve to an outlet of a rough-in valve. Inlets 102 and 103 are associated with hot and cold water inlet cavities 102c and 103c. Cavities 102c and 103c are blind cavities and are perpendicular to and in fluid communication with balancing cavity 104. The term “blind” meaning one cannot see directly through from one cavity to the other, or, a central axis of each cannot pass directly through from one cavity and through the other.

FIG. 1F and FIG. 1G provide views of thermostatic pressure balance valve (TPBV)/manifold assembly 125, according to an embodiment. Thermostatic pressure balance valve/manifold assembly 125 comprises thermostatic valve 126 positioned in chamber 101 of manifold 100. Bonnet nut 127 is threaded onto manifold 100 to secure thermostatic valve 126 in manifold chamber 101. End caps 128 are positioned in both ends of balancing cavity 104, and are configured to hold a ceramic spool (not visible) in place and to seal off cavity 104.

FIG. 1H and FIG. 1I show cross-section views of thermostatic pressure balance valve/manifold assembly 125, according to an embodiment. Thermostatic valve 126 is positioned in central chamber 101 of manifold 100. Check valves 129 are positioned in water inlet cavities 102c and 103c, and are configured to prevent cross-flow between hot and cold water source lines. Visible also is ceramic spool 130 positioned in balancing cavity 104.

FIG. 1J, FIG. 1K, and FIG. 1L provide views of rough-in assembly 135, comprising thermostatic pressure balance valve/manifold assembly 125 positioned in rough-in valve 136. Assembly 125 is secured in a chamber of rough-in valve 136 with threaded cap 141. Rough-in assembly 135 comprises service stops 140, inlet 137 to receive hot source water, inlet 138 to receive cold source water, and outlet 139. Inlet 137 is aligned with manifold inlet 102, and inlet 138 is aligned with manifold inlet 103.

FIG. 1M shows a cross-section view of thermostatic pressure balance rough-in valve assembly 135 containing thermostatic pressure balance valve/manifold assembly 125 positioned in rough-in valve 136, according to an embodiment. Shown are thermostatic pressure balance valve/manifold assembly 125 having thermostatic valve 126 positioned in manifold 100. Manifold outlet 109 is in fluid communication with and configured to discharge mixed water through rough-in valve outlet 139.

FIG. 1N shows shower valve assembly 145, comprising thermostatic pressure balance rough-in valve assembly 135 coupled to diverter valve assembly 146, according to an embodiment. Thermostatic pressure balance rough-in assembly outlet 139 is coupled to diverter valve assembly inlet 152. Diverter valve assembly 146 contains diverter valve 147 positioned in diverter rough-in valve 151. Assembly 145 will have a handle coupled to each of thermostatic valve 126 and diverter valve 147 in use. A handle associated with thermostatic valve 126 will be configured to control temperature, and a handle associated with diverter valve 147 will be configured to provide on/off and diverter functions. Diverter valve assembly 146 contains outlets 148, 149, and 150, configured to deliver mixed water to for example, a shower head, a hand shower, and a tub spout.

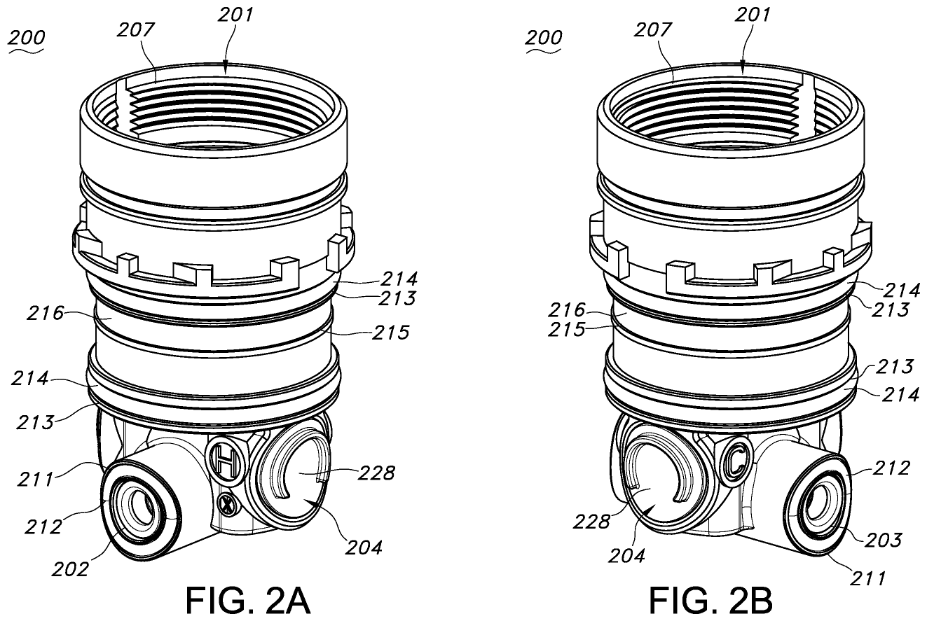

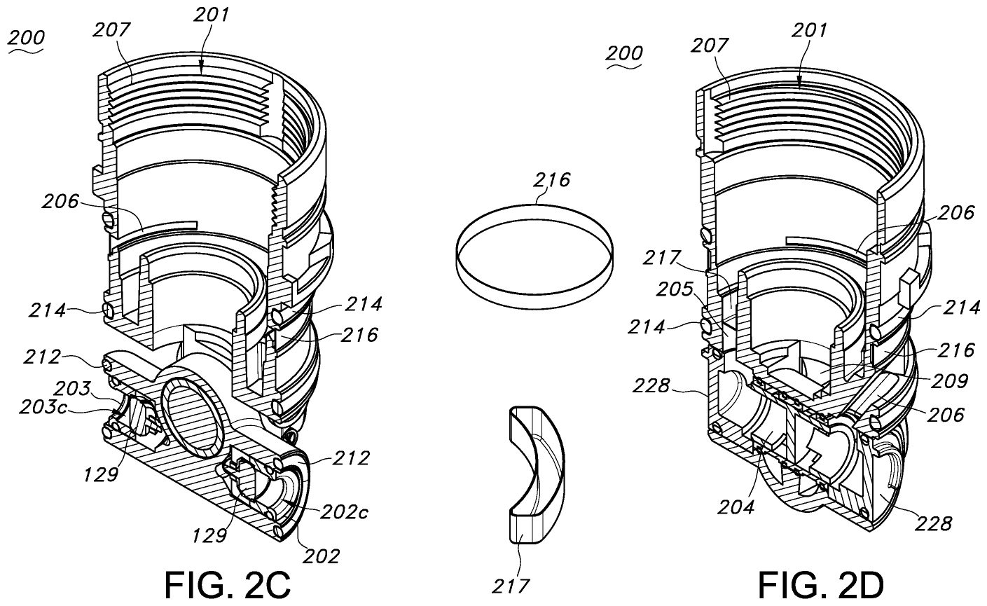

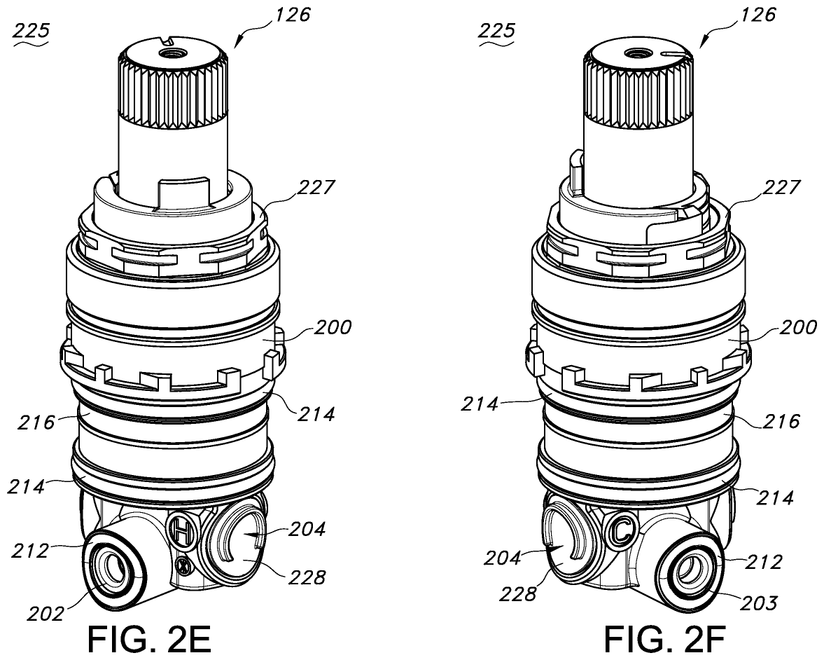

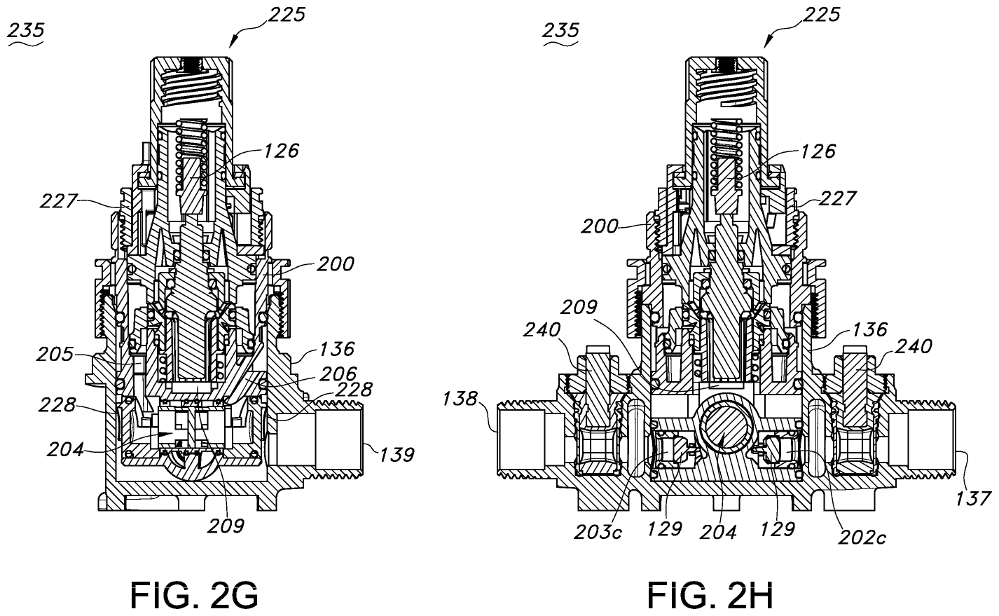

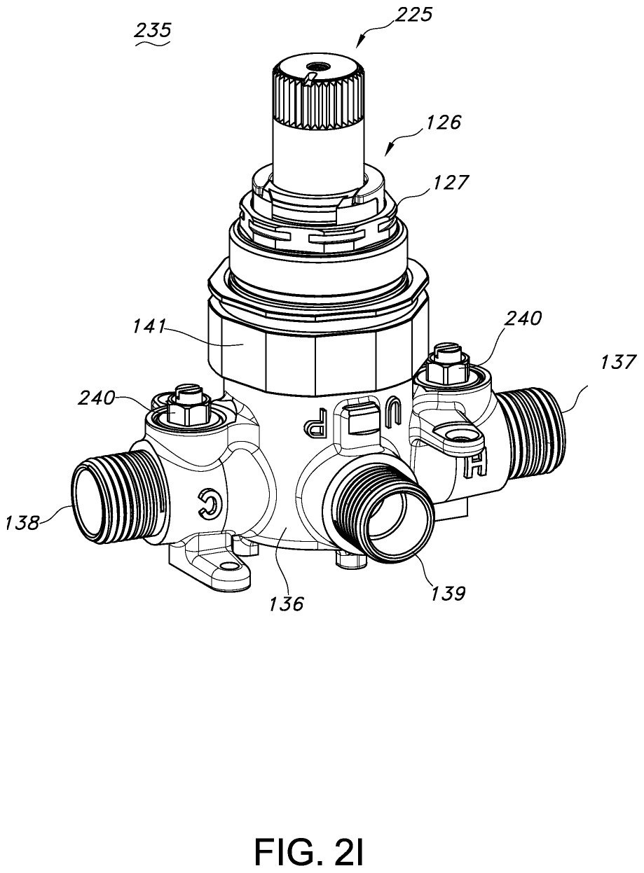

FIG. 2A and FIG. 2B show 90 degree rotation views of valve manifold 200, according to some embodiments. Manifold 200 comprises central chamber 201, having a central axis and configured to receive a thermostatic valve. Manifold 200 contains inlet 202, configured to receive hot water from a hot water source, and inlet 203, configured to receive cold water from a cold water source. Inlets 202 and 203 are configured to pass hot and cold source water to pressure balancing cavity 204, which is configured to receive a pressure balancing device. Balancing cavity 204 (not visible) is positioned behind end caps 228. End caps 228 are positioned in both ends of balancing cavity 204, and are configured to hold a ceramic spool (not visible) in place and to seal off cavity 204. Balancing cavity 204 comprises a central axis perpendicular to the central axis of chamber 201. Inlets 202 and 203 comprise a central axis perpendicular to a central axis of balancing cavity 204. Manifold 200 comprises upper threaded surface 207, positioned at a proximate end of the manifold, and configured to couple to a threaded surface of a bonnet nut to secure a thermostatic valve in chamber 201. Inlets 202 and 203 are associated with groove 211, configured to receive O-ring 212. Manifold 200 comprises circumferential grooves 213, configured to receive large O-rings 214. Manifold 200 comprises circumferential groove 215, configured to receive circumferential cold water filter screen 216. Cold water filter screen 216 is configured to filter cold source water prior to entry into a thermostatic valve.

FIG. 2C and FIG. 2D provide cross-section views of valve manifold 200, rotated 90 degrees, according to some embodiments. Passage 205 is configured to deliver hot water from balancing cavity 204 to a thermostatic valve positioned in chamber 201, and passage 206 is configured to deliver cold water from balancing cavity 204 to a thermostatic valve. Cold water is configured to pass through filter screen 216 before entering a thermostatic valve, and hot water is configured to pass through filter screen basket 217 before entering a thermostatic valve. Filtering of water prior to entering thermostatic valve 126 protects the valve. Manifold 200 comprises outlet 209 configured to deliver hot/cold mixed water from a thermostatic valve to an outlet of a rough-in valve. Inlets 202 and 203 are associated with hot and cold water inlet cavities 202c and 203c. Cavities 202c and 203c are blind cavities and are perpendicular to and in fluid communication with balancing cavity 204. Check valves 129 are positioned in water inlet cavities 202c and 203c, and are configured to prevent cross-flow between hot and cold water source lines.

FIG. 2E and FIG. 2F provide views of thermostatic pressure balance valve/manifold assembly 225, according to an embodiment. Thermostatic pressure balance valve/manifold assembly 225 comprises thermostatic valve 126 positioned in chamber 201 of manifold 200. Bonnet nut 227 is threaded into manifold 200 to secure thermostatic valve 126 in manifold chamber 201. Balancing cavity 204 (not visible) is configured to receive end cap 228 to hold a ceramic spool (not visible) in place and to seal off balancing cavity 204.

FIG. 2G and FIG. 2H provide cross-section views of rough-in assembly 235 containing thermostatic pressure balance valve/manifold assembly 225 positioned in rough-in valve 136, according to an embodiment. Visible are end caps 228, positioned at ends of balancing cavity 204, and configured to hold a ceramic spool (not visible) in place and to seal off cavity 204. Visible are cavity 202c, associated with rough-in valve hot water inlet 137, and cavity 203c, associated with rough-in valve cold water inlet 138. Cavities 202c and 203c are in flow communication with balancing cavity 204 and contain check valves 129, configured to prevent cross-flow between hot and cold water source lines. Also shown are service stops 240 and mixed water outlet 139.

FIG. 2I shows rough-in assembly 235, according to an embodiment. Rough-in valve 136 contains thermostatic pressure balance valve/manifold assembly 225 positioned in a central chamber thereof. Assembly 225 is secured in a central chamber of rough-in valve 136 with threaded cap 141. Assembly 235 comprises service stops 240. Assembly 235 comprises inlet 137, configured to receive hot water from a hot water source, inlet 138 configured to receive cold water from a cold water source, and outlet 139, configured to receive hot/cold mixed water from thermostatic valve 126 and to deliver mixed water ultimately to for example a shower head, hand shower, or a tub spout. Following are labels of the figures.
100, 200 manifold
101, 201 manifold chamber
102, 202 manifold hot water inlet
102c, 202c manifold hot water inlet cavity
103, 203 manifold cold water inlet
103c, 203c manifold cold water inlet cavity
104, 204 pressure balancing cavity
105, 205 manifold hot water passage
105e manifold hot water passage exit point
106, 206 manifold cold water passage
106e manifold cold water passage exit point
107, 207 manifold upper threaded surface
108 manifold central passage
109, 209 manifold outlet
125, 225 TPBV/manifold assembly
126 thermostatic valve
127, 227 bonnet nut
128, 228 balancing cavity end caps
129 check valves
130 ceramic spool
135, 235 rough-in valve assembly
136 rough-in valve
137 rough in valve hot water inlet
138 rough-in valve cold water inlet
139 rough-in valve mixed water outlet
140, 240 service stops
141 threaded cap
145 shower valve assembly
211 manifold inlet grooves to receive O-ring
212 O-ring
213 grooves about manifold body
214 large O-ring
215 manifold groove to receive filter screen
216 cold water filter screen
217 hot water filter screen basket

In some embodiments, a thermostatic pressure balance assembly of the disclosure comprises a manifold, a thermostatic valve, and a pressure balancing device. A manifold may comprise a hot water inlet configured to couple to and receive hot water from a hot water source line, and a cold water inlet configured to couple to and receive cold water from a cold water source line. A manifold may comprise a central chamber configured to receive and couple to a thermostatic valve. A manifold may comprise a pressure balancing cavity configured to have a pressure balancing device positioned therein. A pressure balancing device may comprise a ceramic spool.

A manifold comprises a proximate end and a distal end. A manifold central chamber extends from a manifold proximate end towards a manifold distal end. A manifold proximate end may be configured to couple to a bonnet nut. A bonnet nut may be configured to secure a thermostatic valve in a manifold central chamber.

In some embodiments, a manifold hot water inlet and cold water inlet may be positioned at opposing sides, 180 degrees apart. In some embodiments, a pressure balancing cavity may comprise open ends positioned at opposing sides of a manifold, 180 degrees apart. In some embodiments, a pressure balancing cavity may comprise a central axis perpendicular to a central axis of a hot water inlet and a cold water inlet. In some embodiments, a manifold central chamber may comprise a central axis perpendicular to both a central axis of a pressure balancing cavity and hot and cold water inlets.

Manifold hot and cold water inlets may be positioned at or near a manifold distal end. A pressure balancing cavity may be positioned adjacent manifold hot and cold water inlets, and closer to the manifold proximate end than are the inlets. Manifold hot and cold water inlets are associated with a hot water cavity and a cold water cavity, respectively. The hot and cold water cavities are in flow communication with a pressure balancing cavity and configured to deliver hot and cold source water to the pressure balancing cavity. In some embodiments, the hot and cold water cavities are “blind”, meaning one could not see through from a hot water inlet to a cold water inlet. In some embodiments, the hot and cold water cavities comprise check valves, configured to prevent cross-flow between hot and cold source water lines.

In some embodiments, a pressure balancing cavity open ends may be fitted with end caps, configured to seal off the pressure balancing cavity and hold a pressure balancing device in place. In some embodiments, a pressure balancing cavity open ends may be fitted with an end cap at one end and with a filter cup at the other to seal off the cavity and hold a pressure balancing device in place.

In some embodiments, a manifold, a bonnet nut, and the end caps may comprise a molded thermoplastic. In some embodiments, a molded thermoplastic may include an injection molded thermoplastic. In some embodiments, a thermoplastic may comprise an engineering thermoplastic. Engineering thermoplastics include for example polyamides, polyesters, polycarbonates, acrylonitile-butadiene-styrene, and polyacetals. Polyamides include nylon and polyphthalamide (PPA). Polyacetals include polyoxymethylene (POM).

A manifold may comprise a passage configured to deliver hot water from a balancing cavity to a thermostatic valve, and a passage configured to deliver cold water from a balancing cavity to a thermostatic valve. In some embodiments, a manifold hot water passage is configured to deliver hot water to a mid-section of the thermostatic valve, and a manifold cold water passage is configured to deliver cold water to an upper section of the thermostatic valve.

A manifold may comprise a central passage in fluid communication with a thermostatic valve, and configured to deliver mixed hot/cold water from the thermostatic valve to a manifold outlet.

A thermostatic pressure balance valve assembly may be configured such that a hot water cavity and a cold water cavity are configured to deliver hot and cold source water to a pressure balancing cavity, a pressure balancing device in the pressure balancing cavity is configured to pressure balance of the hot and cold water, the pressure balancing cavity is configured to deliver the pressure balanced hot/cold water to a thermostatic valve, the thermostatic valve is configured to mix the pressure balanced hot/cold source water to a set desired temperature, and the thermostatic valve is configured to deliver the mixed water through a manifold to a manifold outlet.

A thermostatic pressure balance valve assembly may be configured to be disposed in a central chamber of a rough-in valve. A rough-in valve may have a hot water inlet configured to align with and be in flow communication with a manifold hot water inlet, and a cold water inlet configured to align with and be in flow communication with a manifold cold water inlet. A rough-in valve may have an outlet in flow communication with a manifold outlet.

A shower valve assembly may comprise a thermostatic pressure balance rough-in valve assembly coupled to a diverter valve assembly. A diverter valve assembly may comprise a diverter valve positioned in a diverter rough-in valve. A diverter valve assembly may comprise an inlet and two or more outlets. A rough-in valve thermostatic pressure balance valve assembly outlet may be configured to couple to a diverter valve assembly inlet. A diverter valve assembly outlets may be configured to direct/divert water flow to for example a shower head, a hand shower, and a tub spout. A diverter valve and a thermostatic valve are each configured to couple to and be manipulated with a handle in use. A handle associated with a thermostatic valve will be configured to control temperature, and a handle associated with a diverter valve will be configured to provide on/off and diverter functions.

Following are some embodiments of the disclosure.

In a first embodiment, disclosed is a thermostatic pressure balance valve assembly, comprising a manifold; a thermostatic valve; and pressure balancing device, wherein the manifold comprises a hot water inlet configured to receive hot water from a hot water source, a cold water inlet configured to receive cold water from a cold water source, a central chamber, and a pressure balancing cavity, the thermostatic valve is positioned in the manifold central chamber, and the pressure balancing device is positioned in the pressure balancing cavity.

In a second embodiment, disclosed is a thermostatic pressure balance valve assembly according to the first embodiment, wherein the manifold chamber comprises a central axis, the pressure balancing cavity comprises a central axis, and the manifold chamber central axis and the pressure balancing cavity central axis are perpendicular.

In a third embodiment, disclosed is a thermostatic pressure balance valve assembly according to embodiments 1 or 2, wherein the hot water inlet and the cold water inlet each comprise a central axis, and the hot water inlet central axis and the cold water inlet central axis are perpendicular to the manifold chamber central axis and to the pressure balancing cavity central axis.

In a fourth embodiment, disclosed is a thermostatic pressure balance valve assembly according to any of the preceding embodiments, wherein the manifold comprises a proximate end and a distal end, the manifold central chamber extends from the proximate end towards the distal end, the hot water inlet and the cold water inlet are positioned towards the distal end, and the pressure balancing cavity is positioned adjacent to the hot water inlet and the cold water inlet, and nearer the manifold proximate end than are the hot water inlet and the cold water inlet.

In a fifth embodiment, disclosed is a thermostatic pressure balance valve assembly according to any of the preceding embodiments, wherein the pressure balancing device comprises a ceramic spool.

In a sixth embodiment, disclosed is a thermostatic pressure balance valve assembly according to any of the preceding embodiments, wherein the proximate end of the manifold comprises a threaded surface, the manifold threaded surface is threadingly coupled to a bonnet nut, and the bonnet nut is configured to secure the thermostatic valve in the manifold central chamber.

In a seventh embodiment, disclosed is a thermostatic pressure balance valve assembly according to any of the preceding embodiments, wherein the pressure balancing cavity comprises opposing open ends, an end cap is positioned in each pressure balancing cavity open end, or an end cap is positioned in one open end and a filter cup is positioned in the other open end, and the end caps and filter cup are configured to seal off the pressure balancing cavity and to hold the pressure balancing device in place.

In an eighth embodiment, disclosed is a thermostatic pressure balance valve assembly according to any of the preceding embodiments, wherein the hot water inlet and the cold water inlet are positioned at opposing sides of the manifold, the hot water inlet is associated with a hot water cavity and the cold water inlet is associated with a cold water cavity, the hot water cavity and the cold water cavity are in fluid communication with the pressure balancing cavity, and the hot water cavity and the cold water cavity are blind cavities.

In a ninth embodiment, disclosed is a thermostatic pressure balance valve assembly according to any of the preceding embodiments, wherein the hot water inlet is associated with a hot water cavity and the cold water inlet is associated with a cold water cavity, and the hot water cavity and the cold water cavity each comprise a check valve, and the check valves are configured to prevent cross-flow between hot and cold water source lines.

In a tenth embodiment, disclosed is a thermostatic pressure balance valve assembly according to any of the preceding embodiments, wherein the manifold, the bonnet nut, and the end caps comprise a molded thermoplastic.

In an eleventh embodiment, disclosed is a thermostatic pressure balance valve assembly according to any of the preceding embodiments, wherein the manifold comprises a hot water passage configured to deliver hot water from the balancing cavity to the thermostatic valve, and a cold water passage configured to deliver cold water from the balancing cavity to the thermostatic valve.

In a twelfth embodiment, disclosed is a thermostatic pressure balance valve assembly according to any of the preceding embodiments, wherein the manifold comprises a central passage configured to deliver hot/cold mixed water from the thermostatic valve to a manifold outlet.

In a thirteenth embodiment, disclosed is a thermostatic pressure balance valve assembly according to any of the preceding embodiments, wherein the hot water cavity and the cold water cavity are configured to deliver hot and cold source water to the pressure balancing cavity, the pressure balancing device is configured to balance the pressure of the hot water and the cold water, the pressure balancing cavity is configured to deliver pressure balanced hot and cold source water to the thermostatic valve, the thermostatic valve is configured to mix the pressure balanced hot and cold source water to a set temperature, and the thermostatic valve is configured to deliver the mixed water to a manifold outlet.

In a fourteenth embodiment, disclosed is a thermostatic pressure balance rough-in valve assembly comprising a rough-in valve and the thermostatic pressure balance valve assembly according to any of the preceding embodiments, wherein the rough-in valve comprises a central chamber, a hot water inlet, a cold water inlet, and an outlet, the thermostatic pressure balance valve assembly is positioned in the rough-in valve central chamber, the rough-in valve hot water inlet is aligned with and in fluid communication with the manifold hot water inlet, the rough-in valve cold water inlet is aligned with and in fluid communication with the manifold cold water inlet, and the rough-in valve outlet is in fluid communication with the manifold outlet.

In a fifteenth embodiment, disclosed is a shower valve assembly comprising a diverter valve assembly and the thermostatic pressure balance rough-in valve assembly according to embodiment 14, wherein the diverter valve assembly comprises a diverter valve positioned in a diverter rough-in valve, the diverter valve assembly comprises an inlet and two or more outlets, and the thermostatic pressure balance rough-in valve assembly outlet is coupled to the diverter valve assembly inlet.

In a sixteenth embodiment, disclosed is a manifold for a thermostatic pressure balance valve assembly, wherein the manifold comprises a hot water inlet configured to receive hot water from a hot water source, a cold water inlet configured to receive cold water from a cold water source, a central chamber, and a pressure balancing cavity, the central chamber is configured to receive a thermostatic valve, and the pressure balancing cavity is configured to have a pressure balancing device positioned therein.

In a seventeenth embodiment, disclosed is a manifold according to embodiment 16, wherein the manifold chamber comprises a central axis, the pressure balancing cavity comprises a central axis, and the manifold chamber central axis and the pressure balancing cavity central axis are perpendicular.

In an eighteenth embodiment, disclosed is a manifold according to embodiments 16 or 17, wherein the hot water inlet and the cold water inlet each comprise a central axis, and the hot water inlet central axis and the cold water inlet central axis are perpendicular to the manifold chamber central axis and to the pressure balancing cavity central axis.

In a nineteenth embodiment, disclosed is a manifold according to any of embodiments 16 to 18, wherein the manifold comprises a proximate end and a distal end, the manifold central chamber extends from the proximate end towards the distal end, the hot water inlet and the cold water inlet are positioned towards the distal end, and the pressure balancing cavity is positioned adjacent to the hot water inlet and the cold water inlet, and nearer the manifold proximate end than are the hot water inlet and the cold water inlet.

In a twentieth embodiment, disclosed is a manifold according to any of embodiments 16 to 19, wherein the proximate end of the manifold comprises a threaded surface, the manifold threaded surface is configured to threadingly couple to a bonnet nut, and the bonnet nut is configured to secure a thermostatic valve in the manifold central chamber.

In a twenty-first embodiment, disclosed is a manifold according to any of embodiments 16 to 20, wherein the pressure balancing cavity comprises opposing open ends, each configured to receive and couple to an end cap, or one open end configured to receive an end cap and the other configured to receive a filter cup, and the end caps and the filter cup are configured to seal off the pressure balancing cavity and to hold a pressure balancing device in place.

In a twenty-second embodiment, disclosed is a manifold according to any of embodiments 16 to 21, wherein the hot water inlet and the cold water inlet are positioned at opposing sides of the manifold, the hot water inlet is associated with a hot water cavity and the cold water inlet is associated with a cold water cavity, the hot water cavity and the cold water cavity are in fluid communication with the pressure balancing cavity, and the hot water cavity and the cold water cavity are blind cavities.

In a twenty-third embodiment, disclosed is a manifold according to any of embodiments 16 to 22, wherein the hot water inlet is associated with a hot water cavity and the cold water inlet is associated with a cold water cavity, and the hot water cavity and the cold water cavity are each configured to receive a check valve, and the check valves are configured to prevent cross-flow between hot and cold water source lines.

In a twenty-fourth embodiment, disclosed is a manifold according to any of embodiments 16 to 23, wherein the manifold, the bonnet nut, and the end caps comprise a molded thermoplastic.

In a twenty-fifth embodiment, disclosed is a manifold according to any of embodiments 16 to 24, comprising a hot water passage configured to deliver hot water from the balancing cavity to the thermostatic valve, and a cold water passage configured to deliver cold water from the balancing cavity to the thermostatic valve.

In a twenty-sixth embodiment, disclosed is a manifold according to any of embodiments 16 to 25, comprising a central passage configured to deliver hot/cold mixed water from a thermostatic valve to a manifold outlet.

In a twenty-seventh embodiment, disclosed is a manifold according to any of embodiments 16 to 26, wherein the hot water cavity and the cold water cavity are configured to deliver hot and cold source water to the pressure balancing cavity, the pressure balancing device is configured to balance the pressure of the hot water and the cold water, the pressure balancing cavity is configured to deliver pressure balanced hot and cold source water to the thermostatic valve, the thermostatic valve is configured to mix the pressure balanced hot and cold source water to a set temperature, and the thermostatic valve is configured to deliver the mixed water to a manifold outlet.

In a twenty-eighth embodiment, disclosed is a pressure balance valve assembly, a manifold, or a thermostatic pressure balance rough-in valve assembly according to any of the preceding embodiments, comprising a filter screen having an annular shape positioned about the manifold, and configured to filter cold source water prior to entry into a thermostatic valve. An annular filter screen may be positioned in a cold water passage.

In a twenty-ninth embodiment, disclosed is a pressure balance valve assembly, a manifold, or a thermostatic pressure balance rough-in valve assembly according to embodiment 28, wherein the manifold comprises a circumferential groove configured to receive the annular-shaped filter screen.

In a thirtieth embodiment, disclosed is a pressure balance valve assembly, a manifold, or a thermostatic pressure balance rough-in valve assembly according to any of the preceding embodiments, wherein the manifold comprises a filter screen basket positioned in a hot water passage, configured to filter hot source water prior to entry into a thermostatic valve. A filter screen basket may comprise a curved, partial-annular shape configured to be received by a manifold.

The term “flow communication” or “fluid communication” means for example configured for liquid or gas flow therethrough and may be synonymous with “fluidly coupled”. The terms “upstream” and “downstream” indicate a direction of gas or fluid flow, that is, gas or fluid will flow from upstream to downstream.

Likewise, “electrical communication” may mean “electrically coupled”. Electrical communication may be via wired connection or may be wireless.

The terms “coupled” or “connected” may mean that an element is “attached to” or “associated with” another element. Coupled or connected may mean directly coupled or coupled through one or more other elements. An element may be coupled to an element through two or more other elements in a sequential manner or a non-sequential manner. The term “via” in reference to “via an element” may mean “through” or “by” an element. Coupled or connected or “associated with” may also mean elements not directly or indirectly attached, but that they “go together” in that one may function together with the other.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by 10.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

### Example

Testing is performed with a 50 foot pipe length from a hot water heater to a shower valve, a cold water inlet temperature of 70° F. (21° C.), a hot water inlet temperature of 150° F. (65.5° C.), a showering temperature of 100-101° F. (30° C.), and a showering time of 7 minutes. Results for a shower warm-up phase for a present thermostatic pressure balance valve assembly (TPBV) vs. a conventional pressure balance valve assembly (PBV) are shown below, wherein the water temperature is allowed to reach the showering temperature. Results are also provided for a total shower. In Scenario 1, the conventional PBV valve is set to a temperature position of 100° F. In Scenario 2, the conventional PBV is set to full hot, and after reaching 140° F., is turned down to the showering temperature of 100° F. The TPBV is set to the showering temperature.

### Scenario 1 Warm-Up

| | |
|---|---|
| TPBV | PBV |

| | | | | |
|---|---|---|---|---|
| minimum wait time | 30 | seconds | 2 | minutes |
| total water consumption | 0.78 | gallons | 3.6 | gallons |
| hot water consumption | 0.72 | gallons | 1.3 | gallons |
| thermal energy consumption | 482 | BTU | 866 | BTU |

### Scenario 2 Warm-Up

| | |
|---|---|
| TPBV | PBV |

| | | | | |
|---|---|---|---|---|
| minimum wait time | 30 | seconds | 1 | minute |
| total water consumption | 0.78 | gallons | 1.54 | gallons |
| hot water consumption | 0.72 | gallons | 1.25 | gallons |
| thermal energy consumption | 482 | BTU | 836 | BTU |

### Scenario 1 Full Shower

| | |
|---|---|
| TPBV | PBV |

| | | | | |
|---|---|---|---|---|
| total water consumption | 13.4 | gallons | 16.2 | gallons |
| hot water consumption | 5.27 | gallons | 5.85 | gallons |
| thermal energy consumption | 3527 | BTU | 4132 | BTU |

### Scenario 2 Full Shower

| | |
|---|---|
| TPBV | PBV |

| | | | | |
|---|---|---|---|---|
| total water consumption | 13.4 | gallons | 14.1 | gallons |
| hot water consumption | 5.27 | gallons | 5.80 | gallons |
| thermal energy consumption | 3527 | BTU | 3879 | BTU |

It is seen that in each scenario of how a person might adjust a shower water temperature, that a present thermostatic pressure balance valve provides for significant water and energy savings.

1. A thermostatic pressure balance valve assembly, comprising a manifold;
a thermostatic valve; and
pressure balancing device,
wherein
the manifold comprises a hot water inlet configured to receive hot water from a hot water source, a cold water inlet configured to receive cold water from a cold water source, a central chamber, and a pressure balancing cavity,
the thermostatic valve is positioned in the manifold central chamber, and
the pressure balancing device is positioned in the pressure balancing cavity.

2. The thermostatic pressure balance valve assembly according to claim 1, wherein
the manifold chamber comprises a central axis,
the pressure balancing cavity comprises a central axis, and
the manifold chamber central axis and the pressure balancing cavity central axis are perpendicular.

3. The thermostatic pressure balance valve assembly according to claim 1, wherein
the hot water inlet and the cold water inlet each comprise a central axis, and
the hot water inlet central axis and the cold water inlet central axis are perpendicular to the manifold chamber central axis and to the pressure balancing cavity central axis.

4. The thermostatic pressure balance valve assembly according to claim 1, wherein
the manifold comprises a proximate end and a distal end,
the manifold central chamber extends from the proximate end towards the distal end,
the hot water inlet and the cold water inlet are positioned towards the distal end, and
the pressure balancing cavity is positioned adjacent to the hot water inlet and the cold water inlet, and nearer the manifold proximate end than are the hot water inlet and the cold water inlet.

5. The thermostatic pressure balance valve assembly according to claim 1, wherein the pressure balancing device comprises a ceramic spool.

6. The thermostatic pressure balance valve assembly according to claim 1, wherein
the proximate end of the manifold comprises a threaded surface,
the manifold threaded surface is threadingly coupled to a bonnet nut, and
the bonnet nut is configured to secure the thermostatic valve in the manifold central chamber.

7. The thermostatic pressure balance valve assembly according to claim 1, wherein
the pressure balancing cavity comprises opposing open ends,
an end cap is positioned in each pressure balancing cavity open end, or an end cap is positioned in one open end and a filter cup is positioned in the other open end, and
the end caps and filter cup are configured to seal off the pressure balancing cavity and to hold the pressure balancing device in place.

8. The thermostatic pressure balance valve assembly according to claim 1, wherein
the hot water inlet and the cold water inlet are positioned at opposing sides of the manifold,
the hot water inlet is associated with a hot water cavity and the cold water inlet is associated with a cold water cavity,
the hot water cavity and the cold water cavity are in fluid communication with the pressure balancing cavity, and
the hot water cavity and the cold water cavity are blind cavities.

9. The thermostatic pressure balance valve assembly according to claim 1, wherein
the hot water inlet is associated with a hot water cavity and the cold water inlet is associated with a cold water cavity, and
the hot water cavity and the cold water cavity each comprise a check valve, and
the check valves are configured to prevent cross-flow between hot and cold water source lines.

10. The thermostatic pressure balance valve assembly according to claim 1, wherein the manifold comprises a molded thermoplastic.

11. The thermostatic pressure balance valve assembly according to claim 1, wherein the manifold comprises a hot water passage configured to deliver hot water from the balancing cavity to the thermostatic valve, and a cold water passage configured to deliver cold water from the balancing cavity to the thermostatic valve.

12. The thermostatic pressure balance valve assembly according to claim 1, wherein the manifold comprises a circumferential groove configured to receive an annular-shaped filter screen, the filter screen configured to filter cold source water prior to entering the thermostatic valve.

13. The thermostatic pressure balance valve assembly according to claim 1, wherein the manifold comprises a curved, basket-shaped filter screen positioned in a hot water passage and configured to filter hot source water prior to entering the thermostatic valve.

14. The thermostatic pressure balance valve assembly according to claim 1, wherein the manifold comprises a central passage configured to deliver hot/cold mixed water from the thermostatic valve to a manifold outlet.

15. The thermostatic pressure balance valve assembly according to claim 1, wherein
the hot water cavity and the cold water cavity are configured to deliver hot and cold source water to the pressure balancing cavity,
the pressure balancing device is configured to balance the pressure of the hot water and the cold water,
the pressure balancing cavity is configured to deliver pressure balanced hot and cold source water to the thermostatic valve,
the thermostatic valve is configured to mix the pressure balanced hot and cold source water to a set temperature, and
the thermostatic valve is configured to deliver the mixed water to a manifold outlet.

16. A thermostatic pressure balance rough-in valve assembly comprising a rough-in valve and the thermostatic pressure balance valve assembly according to claim 1, wherein
the rough-in valve comprises a central chamber, a hot water inlet, a cold water inlet, and an outlet,
the thermostatic pressure balance valve assembly is positioned in the rough-in valve central chamber,
the rough-in valve hot water inlet is aligned with and in fluid communication with the manifold hot water inlet,
the rough-in valve cold water inlet is aligned with and in fluid communication with the manifold cold water inlet, and
the rough-in valve outlet is in fluid communication with the manifold outlet.

17. A shower valve assembly comprising a diverter rough-in valve and the thermostatic pressure balance rough-in valve assembly according to claim 16, wherein
the diverter rough-in valve is configured to receive a diverter valve,
the diverter rough-in valve comprises an inlet and two or more outlets, and
the thermostatic pressure balance rough-in valve assembly outlet is coupled to the diverter rough-in valve inlet.

18. A manifold for a thermostatic pressure balance valve assembly, wherein
the manifold comprises a hot water inlet configured to receive hot water from a hot water source, a cold water inlet configured to receive cold water from a cold water source, a central chamber, and a pressure balancing cavity,
the central chamber is configured to receive a thermostatic valve, and
the pressure balancing cavity is configured to have a pressure balancing device positioned therein.

19. The manifold according to claim 18, wherein the manifold comprises a circumferential groove configured to receive an annular-shaped filter screen, the filter screen configured to filter cold source water prior to entering the thermostatic valve.

20. The manifold according to claim 18, wherein
the manifold comprises a proximate end and a distal end,
the manifold central chamber extends from the proximate end towards the distal end,
the hot water inlet and the cold water inlet are positioned towards the distal end, and
the pressure balancing cavity is positioned adjacent to the hot water inlet and the cold water inlet, and nearer the manifold proximate end than are the hot water inlet and the cold water inlet.
